(19) United States
(12) Patent Application Publication
(10) Pub. No.: US 2009/0152896 A1
(43) Pub. Date: Jun. 18, 2009

(54) REINFORCEMENT MODULE FOR A MOTOR VEHICLE BODY

(75) Inventors: Thomas Enderich, Hünstetten (DE); Stanislaw Klimek, Frankfurt (DE); Lothar Teske, Aschaffenburg (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/297,046

(22) PCT Filed: May 9, 2007
(86) PCT No.: PCT/EP07/04083

§ 371 Date: Oct. 13, 2008

(30) Foreign Application Priority Data
May 11, 2006 (DE) 102006021883.3

(51) Int. Cl. B62D 21/15

(52) U.S. Cl. 296/187.03; 403/343

(57) ABSTRACT

A reinforcement module is provided for a motor vehicle body. It may be brought into contact on a body part and fastened thereto. The cited body part having multiple fastening points for motor vehicle components to be mounted. In the reinforcement module, at least one fastener fastened or integrated on or partially in the reinforcement module is assigned to each fastening point of the body part for fastening the door panel module to the vehicle body.

### CROSS-REFERENCE TO RELATED APPLICATION

This application is a U.S. National-Stage entry under 35 U.S.C. § 371 based on International Application No. PCT/EP2007/004083, filed May 9, 2007, which was published under PCT Article 21(2) and which claims priority to German Application No. 102006021883.3, filed May 11, 2006, which are all hereby incorporated in their entirety by reference.

### TECHNICAL FIELD

The invention relates to a reinforcement module for a motor vehicle body, which may be used, inter alia, for vertical struts of a passenger automobile, which are typically referred to as A-, B-, and C-columns.

### BACKGROUND

In addition to ensuring a high level of driving comfort, securing optimum protection of the vehicle occupants is an important concern in the development of new vehicles. While a larger deformation or crumple zone is nominally available in the event of a frontal impact, the requirements for good occupant protection are more difficult to fulfill in the event of a side impact.

To protect the vehicle occupants, a vehicle must pass collision and/or crash tests before being permitted in the various countries. These include, inter alia, a side impact test according to EuroNCAP (European New Car Assessment Program) using a deformable barrier for the upper vehicle body area and a side impact test according to EuroNCAP using a rigid column for the lower vehicle body area. These tests are being refined and the criteria to be fulfilled are becoming increasingly stricter.

For compliance with the above collision tests, equipping the vertical struts with local reinforcements to stiffen them is known. This applies in particular for the B-column, which is especially important for ensuring good side impact protection. In manufacturing, all local reinforcements are positioned and welded to the vehicle body in consideration of the tolerances to be maintained. Furthermore, numerous subassemblies are controlled and installed.

Furthermore, implementing the vertical struts more solidly either as a whole or locally for the purpose of improved side impact protection is known.

It is at least one object of one embodiment of the present invention to provide a reinforcement module for a vehicle body, using which improved occupant protection is achieved. In addition, other objects, desirable features, and characteristics will become apparent from the subsequent summary, detailed description, and the appended claims, taken in conjunction with the accompanying drawings and this background.

### SUMMARY

This at least one object is achieved according to one embodiment with a reinforcement module for a motor vehicle body, which may be brought to rest on a vehicle body part and fastened thereon or therewith. The vehicle body part has multiple fastening points for motor vehicle components to be mounted. At least one fastener fastened on or at least partially in the reinforcement module is assigned to each fastening point for fastening the reinforcement module to the vehicle body part.

The fastener module is used on one hand for reinforcing the body part as a whole and on the other hand for reinforcing a plurality of local fastening points. For the second function, it is equipped at each of the fastening points of the body part with a fastener, using which the motor vehicle component to be fastened and the reinforcement module may be fastened to the body part.

Computer-simulated collision tests have shown that a vehicle equipped with the above reinforcement module ensures improved side impact protection according to EuroNCAP using rigid column in comparison to the case of a plurality of fastening points each only having local reinforcement. The reason for this is the stiffening effect of the reinforcement module in the side body area. In addition, for the purpose of improved side impact protection, only a single reinforcement module is to be fastened to the cited body part (e.g., only one single reinforcement module to the B-column), which decreases the production time of the vehicle and thus saves costs. In addition, with uniform side impact protection, in spite of the reinforcement module as an additional part, the weight of the vehicle body as a whole comes out to be less. The reason is that the above-mentioned material thickened areas on the body part are dispensed with and, as will be explained below, a more flexible material mix is possible in the reinforcement module using lighter materials.

Furthermore, using the reinforcement module, the individual fastening points become more robust in relation to torques acting on the fastening points, by which deformations or lacquer breaks are less probable in case of strain.

Embodiments are provided which have a screw, a screw nut, a through opening, a catch element, a clip, or a similar object as a fastener. If the fasteners are used to produce a screw connection, the lever arm, which is decisive for the forced work, may be set by the predefinable distance between screw head and screw nut. The fastening point thus becomes more robust in relation to acting torques in the meaning of the statements of the last paragraph.

One embodiment of the reinforcement module provides a screw as the fastener, and furthermore the reinforcement module has one of its screws projecting through a hole of the body part located at a fastening point in its fastening position on the body part. During mounting, the reinforcement module is applied and its screws are guided through corresponding openings or holes of the body part. A motor vehicle component to be fastened is subsequently brought into contact and the screw connection is completed using a screw nut.

Furthermore, one embodiment of the reinforcement module may be composed in such a way that a screw nut is provided as a fastener and the reinforcement module is situated in its fastening position on the body part of one of its screw nuts in such a way that a screw which may be guided through a hole of the body part located on a fastening point may be screwed into the cited screw nut. During the mounting, the screw is first guided through a hole of the motor vehicle component to be fastened, then through the body part, and finally through the reinforcement module.

In an additional embodiment, the reinforcement module has a sleeve in its through opening at the fastening point. A screw may be guided through the sleeve to produce a screw connection.

A further embodiment of the reinforcement module has flanges for flush application and fastening to a part of a vertical strut. The flange is used to produce a glued connection between reinforcement module and body part. Alternatively to the glued connection, a clip or catch connection may also be selected.

Furthermore, a further embodiment of the reinforcement module is at least partially manufactured from plastic and/or has multiple through openings. The fastening points are thus not reinforced using heavy weldable metal parts, but rather via lighter materials such as plastics, which also include composite materials. As a function of the local requirements for side impact protection, a more optimum material mix may be selected overall in regard to its weight. The wall thickness for the body part may simultaneously be decreased, so that the vehicle weight may be reduced overall.

Furthermore, a further embodiment of the invention provides for a motor vehicle having a vehicle body in which a reinforcement module as previously described is fastened to a part of the vehicle body. The body part may be a vertical strut such as the B-column, through which improved side impact protection results for the vehicle using the reinforcement part.

### BRIEF DESCRIPTION OF THE DRAWINGS

The present invention will hereinafter be described in conjunction with the following drawing figures, wherein like numerals denote like elements, and

FIG. 1A shows a side view of a body part;

FIG. 1B shows a top view of a body part;

FIG. 1C though 1F shows sections through the body part of FIG. 1B;

FIG. 2A shows a side view of a reinforcement part incorporated in the body part of FIG. 1A;

FIG. 2B shows a top view of the configuration of FIG. 2A;

FIG. 2C through FIG. 2F shows sections through the configuration of FIG. 2A;

FIG. 3 shows a section according to FIG. 2C in the detail view according to a first embodiment;

FIG. 4 shows a further section according to FIG. 2C in the detail view according to a further embodiment; and

FIG. 5 shows a section according to FIG. 2C in the detail view according to a further embodiment.

### DETAILED DESCRIPTION

The following detailed description is merely exemplary in nature and is not intended to limit application and uses. Furthermore, there is no intention to be bound by any theory presented in the preceding summary and background or the following detailed description.

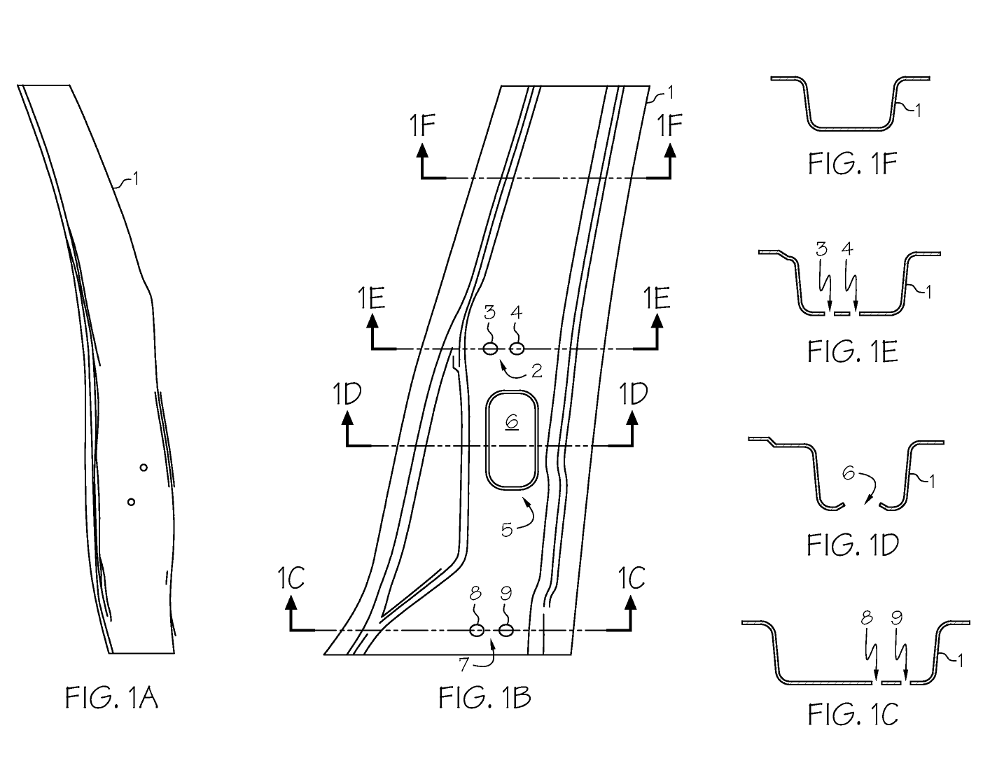

FIG. 1a shows a body part 1 in a side view and FIG. 1b shows a top view. The body part 1 is a part of the B-column having a fastening point 2 in the form of two holes 3, 4 for the upper fastening of the door hinge, a fastening point 5 in the form of a material opening 6, and a further fastening point 7 in the form of holes 8, 9 for the lower fastening of the door hinge. The material opening 6 is used as a cable feed-through and plug fastener for the electrical and control cable of the rear vehicle door. Further fastening points for fastening other vehicle components, for example, for fastening the striker of the door lock or the door brake are not shown for reasons of simplification.

FIG. 1c shows four sections through the reinforcement part of FIG. 1b along lines A-A, B-B, C-C, and D-D. It may be seen that body part 1 essentially has a hat-shaped profile and the fastening points cited at the beginning are each located on the floor of the hat profile.

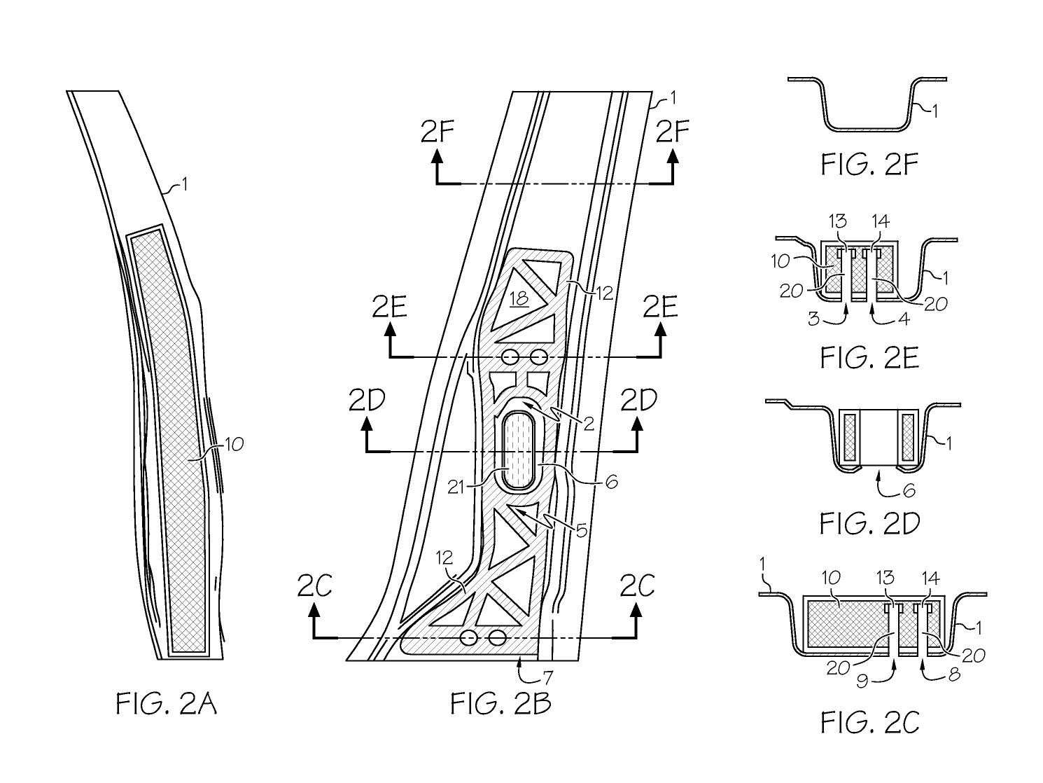

FIGS. 2a-c correspond to FIGS. 1a-c, but the body part 1 is supplemented by a reinforcement module 10 here.

FIG. 2a shows that it is situated in the hat-shaped profile of the body part 1 and disappears therein in the side view. The reinforcement module 10 may be glued via a flange 11 to the body part 1 or connected thereto via a clip connection (not shown).

FIG. 2b shows that the reinforcement module 10 may, but does not have to be implemented as solid. In the embodiment of FIG. 2b, it comprises multiple webs 12 which form a latticed reinforcement module 10 as a whole. There are also through openings 18 between the webs 12, using which the weight of the reinforcement module 10 may be limited. Selected parts of the reinforcement module 10, for example, those in the area of the fastening points 2, 5, 7, may be implemented as solid. A material mix having lighter and heavier materials may also be selected, whose type and configuration is selected in such a way that the occupant protection is optimum in the event of a side impact.

FIG. 2c shows sections A-A, B-B, C-C, and D-D corresponding to the sections of FIG. 1c. Section A-A shows a first fastening point 7, which is used for the lower fastening of the door hinge. The reinforcement module 10 is implemented as solid there and two screw nuts 13, 14 are introduced and/or embedded therein. This may be performed in such a way that the reinforcement module 10 is a plastic block having embedded screw nuts 13, 14 at the fastening point 4. During the mounting, a screw inserted via the holes 8, 9 into the cylindrical openings 20 is screwed into the screw nuts 13, 14.

Section B-B shows the area of a second fastening point 5, where a plug 21 for the electrical and control cable of the rear vehicle door is fastenable. The reinforcement module 10 is also not implemented as solid here, but rather also allows the passage of a cable having plug 21 through the material opening 6. The cable may be embedded in the reinforcement module 10 on the side of the reinforcement module 10. The plug 21 is held suitably by the reinforcement module, for example, using a clip connection (not shown). The body part 1 is reinforced by the reinforcement module 10 on the right and left of the material opening 6 here. Horizontal webs 12 stabilize the reinforcement module 12 as a whole.

Section C-C shows the area of a third fastening point 2, where the door hinge is fastened on top on the body part 1. The reinforcement module 10 also has incorporated and/or integrated screw nuts 13, 14 here, as at the fastening point 7.

Section D-D also shows an area without a reinforcement module 10.

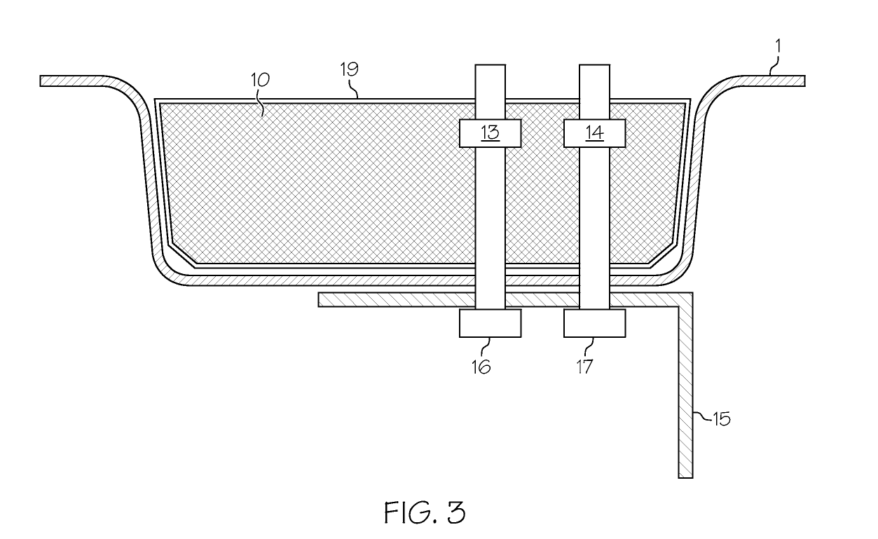

FIG. 3 shows a detail view of section C-C at the fastening point 7 for fastening a hinge 15 on the body part 1 having two screws 16, 17 screwed into the screw nuts 13, 14. The screw nuts 13, 14 are located in the reinforcement module 10 in FIG. 3. However, they may also be situated on the side of the reinforcement module 10 facing away from the hinge 15 on its surface 19 and thus be positioned on or at the reinforcement module 10.

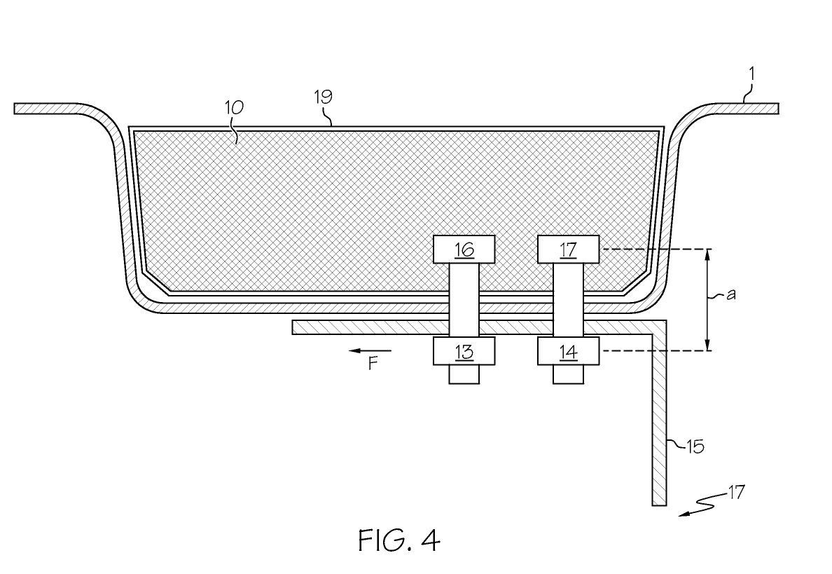

FIG. 4 shows the case corresponding to FIG. 3, in which screws 16, 17 are introduced into the reinforcement module 10. By integrating the screws 16, 17 into the reinforcement module 10 or, similarly, the nuts 13, 14 in the reinforcement part 10 according to FIG. 3, the distance screw head-screw nut may be set in a targeted way. If a torque M is exerted on the construction, a smaller force F=M/a acts on the screws 16, 17 in the event of a greater lever arm a (this is the distance screw head-screw nut). Due to the increase of the lever arm a, the fastening point may thus be mechanically loaded more strongly in case of a side impact, without local deformations or lacquer breaks occurring there.

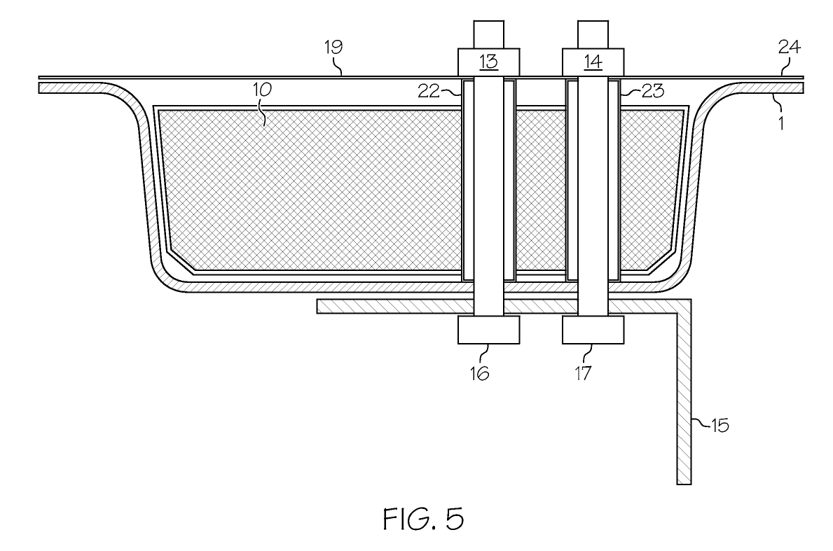

FIG. 5 shows a section C-C having a through opening 18, for example, in the form of a cylindrical opening 20, at the fastening point 7, into which a sleeve 22, 23 is introduced. During mounting, the screws 16 and 17 are pushed from below through the sleeve 22, 23 and screwed to the screw nut 13 or 14 on top above or below the striker plate 24.

The above embodiments show that the reinforcement module 10 is used to locally reinforce three fastening points 2, 5, and 7. It is to be noted here that still further fastening points may be reinforced using the reinforcement module 10, for example, all fastening points of the body part 1. The reinforcement is performed using a single reinforcement module 10, which is connected rapidly to the body part 1 in the mounting using an adhesive, clip, welded, or other connection. The reinforcement of all fastening points is thus performed easily, rapidly, and cost-effectively in relation to a procedure in which the fastening points 2, 5, 7, etc. are reinforced individually. Improved protection in relation to intrusions may be achieved for the case of a side impact by shaping and material selection for the reinforcement module 10. Simultaneously, the weight of the vehicle body may be decreased as a whole in spite of the additional reinforcement module 10. This is because local material thickened areas in the body part 1 may be avoided and light materials (e.g., fiber composite materials) may also be used for the reinforcement.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A reinforcement module for a motor vehicle body, that may brought into contact on a body part and is also fastenable to the body part, comprising:
a plurality of fastening points for vehicle components to be mounted; and
at least one fastener assigned to each of the plurality of fastening points and at least partially fastened in the reinforcement module for fastening the reinforcement module to the body part.

2. The reinforcement module according to claim 1, wherein a screw is provided as the at least one fastener.

3. The reinforcement module according to claim 1, the reinforcement module further comprises a plurality of module screws projecting through a hole of the body part located on a fastening point in a fastening position on the body part.

4. The reinforcement module according to claim 2, further comprising a screw nut for the screw that is situated in a fastening position on the body part in such a way that the screw which may be guided through a hole of the body part located at a fastening point, may be screwed into the screw nut.

5. The reinforcement module according to claim 1, further comprising a through opening at at least one of the fastening points and having a sleeve situated in the through opening.

6. The reinforcement module according to claim 1, further comprising a flanges for flush contact on and fastening to a part of a vertical strut.

7. The reinforcement module according to claim 1, further comprising a clip connection adapted to fasten the reinforcement module to the body part in a clip connection.

8. The reinforcement module according to claim 1, wherein the reinforcement module is at least partially manufactured from a plastic.

9-11. (canceled)
